(19) United States
(12) Patent Application Publication
(10) Pub. No.: US 2006/0182252 A1
(43) Pub. Date: Aug. 17, 2006

(54) Method and apparatus for maintaining automated call transfers between service centers

(75) Inventors: Jon Harris, Little Elm, TX (US); Jon Paden, Austin, TX (US); Paul Dent, Austin, TX (US); Bobby Sams, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/048,426

(22) Filed: Feb. 1, 2005

(51) Int. Cl. H04M 3/42

(52) U.S. Cl. 379/211.01

(57) ABSTRACT

In a call transfer system (110) a computer program can transfer a calling party (102A) communicating with a first agent (106A) at a first communication switch when said first communication switch does not support automated call transfers. The computer program includes instructions for receiving (212) a call from the first agent, selecting (224) a second agent (106B) at a second communication switch according to a request received from the first agent, connecting (226-228) the second agent at the second communication switch with one or more of a group of parties comprising the calling party and the first agent, and activating automated call transfers at the second communication switch.

### FIELD OF THE INVENTION

This invention relates generally to service centers, and more particularly to a method and apparatus for maintaining automated call transfers between service centers.

### BACKGROUND OF THE INVENTION

Generally, agents who receive calls at IVR (Interactive Voice Response) service centers utilize transfer codes to redirect the caller when the agent is unable to address the needs of the caller. The transfer codes in turn connect the caller with another agent at an alternate site. This simple transfer process is performed in a seamless manner so as to serve the caller's need promptly, effectively and to the satisfaction of the caller.

There are, however, many service providers utilizing proprietary IVR systems that are not interoperable, and accordingly do not support transfer codes in all instances. In such environments, agents are not able to readily transfer a calling party. At times agents resort to asking the caller to hang up and call another number, which is a source of frustration for both the caller and the agent.

### SUMMARY OF THE INVENTION

Embodiments in accordance with the invention provide a method and apparatus for maintaining automated call transfers between service centers.

In a first embodiment of the present invention, a call transfer system operates in computer-readable storage medium for transferring a calling party communicating with a first agent at a first communication switch when said first communication switch does not support automated call transfers. The storage medium includes computer instructions for receiving a call from the first agent, selecting a second agent at a second communication switch according to a request received from the first agent, connecting the second agent at the second communication switch with one or more of a group of parties comprising the calling party and the first agent, and activating automated call transfers at the second communication switch.

In a second embodiment of the present invention, a call transfer system coupled to a communication network can transfer a calling party communicating with a first agent at a first communication switch when said first communication switch does not support automated call transfers. The call transfer system includes a memory, and a processor coupled to the memory. The processor is programmed to receive a call from the first agent, select from the memory a second agent at a second communication switch according to a request received from the first agent, connect the second agent at the second communication switch with one or more of a group of parties comprising the calling party and the first agent, and activate automated call transfers at the second communication switch.

In a third embodiment of the present invention, a service center operates according to a method at a first agent including the steps of receiving a call from a calling party at a first communication switch, determining that the calling party needs to be transferred to a second agent, determining that the first communication switch does not support an automated call transfer to the second agent, placing the calling party on hold, calling a call transfer system, and supplying to the call transfer system a transfer code corresponding to the second agent. The method at the call transfer system further includes the steps of receiving a call from the first agent, selecting the second agent at a second communication switch according to the transfer code received from the first agent, connecting the second agent at the second communication switch with one or more of a group of parties comprising the calling party and the first agent, and activating automated call transfers at the second communication switch.

### BRIEF DESCRIPTION OF THE DRAWINGS

FIG. 1 is a block diagram of a number of service centers managed by a service provider in accordance with an embodiment of the present invention;

FIG. 2 is a block diagram of a call transfer system of FIG. 1 in accordance with an embodiment of the present invention; and

FIGS. 3-4 are flow charts depicting a method in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

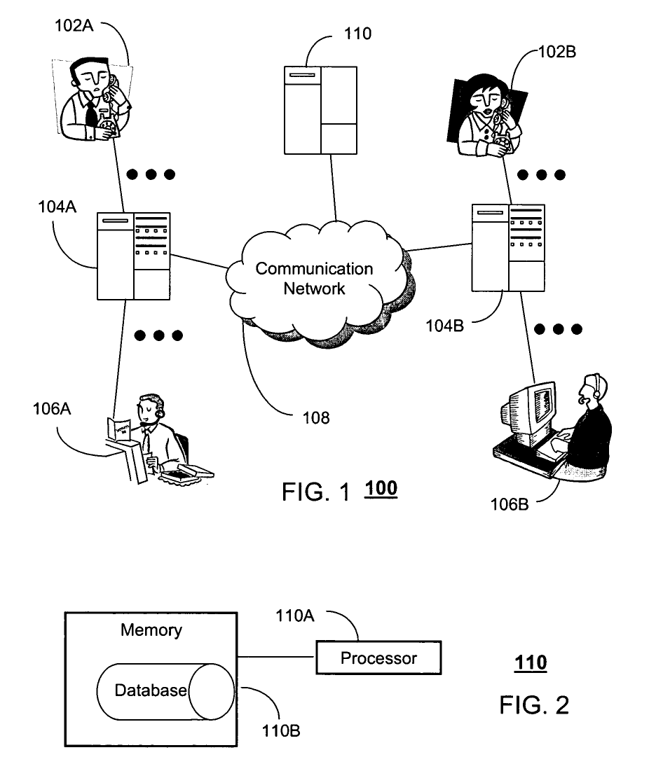

FIG. 1 is a block diagram 100 of a number of service centers 104A-B managed by a service provider in accordance with an embodiment of the present invention. Each service center 104A-B can receive a number of calls from calling parties 102A-B (only two shown—although could be more), which in turn can be connected with any number of agents 106A-B (only two shown—although could be more) who can assist a caller. The service centers 104A-B are interconnected by way of a conventional communication network 108 such as a PSTN (Public Switch Telephone Network). Each service center 104A-B includes a conventional communication switch (e.g., a central office switch like a 5ESS Telephone Switching System or similar larger or smaller switching system) for interconnecting calling parties 102A-B and agents 106A-B, respectively. The service centers 104A-B can also include the functionality of a conventional IVR (Interactive Voice Response) system which can be used to navigate a calling party 102 through a number of voice menus before interconnecting said caller 102 with an agent 106.

What follows is a procedure used by agents 106 in prior art systems when service centers 104 support interoperable call transfer functions. There are instances when a first agent 106A determines that a second agent at a second service center 104B can better serve the needs of a calling party 102A. This second agent is assumed to be agent 106B for illustration purposes. When this happens, the first agent 106A enters a site code (such as *8) at its service center 104A, which in turn triggers the communication switch of service center 104A (herein referred to as the first communication switch) to place the calling party 102A on hold. The first agent 106A then hears a dial tone, and enters a transfer code (2-7 digit code) selected from a list of transfer codes associated with other agents available throughout the service provider's service centers 104. The list of transfer codes is provided to the first agent 106A in print or on a computer screen. The list also identifies the skill or know-how of each agent so that the agent making the transfer can select an agent that can best serve the needs of the calling party 102A.

Once the transfer code has been entered, the service center 104A instructs the communication network 108 to interconnect the first agent 106A with the second agent 106B at the communication switch of service center 104B (herein referred to as the second communication switch). Once the first agent 106A explains the needs of the calling party 102A to the second agent 106B, the first agent 106A conferences the calling party 102A with the second agent 106B by entering a conventional conference code (such as *4), which triggers the first communication switch of service center 104A to join the calling party 102A on the same communication line. The first agent 106A at that point can stay on the same line if s/he can serve a useful purpose, or drop off the line so as to allow the second agent 106B to address the needs of the calling party 102A exclusively.

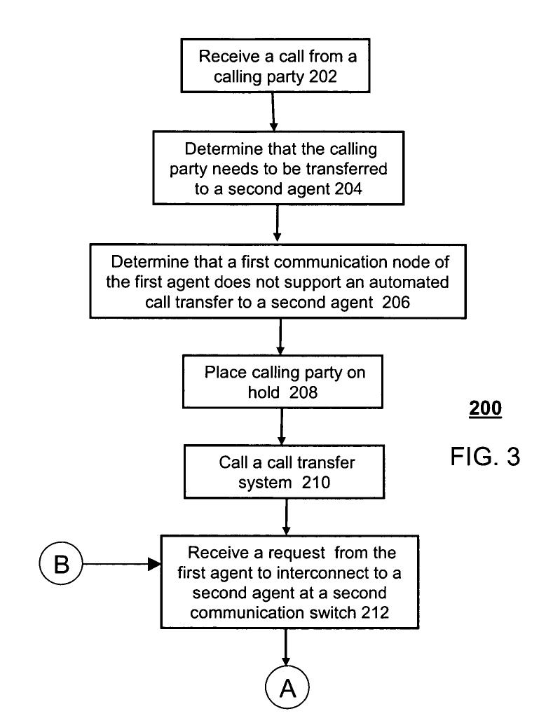

As noted earlier, it is common in prior art systems for a number of proprietary service centers 104 under the management of a single service provider to not support interoperable call transfer functions such as described above. In such circumstances, an agent who attempts to interconnect a calling party with another agent will not be able to follow the procedure described above. To overcome this limitation in the art, the present invention utilizes a call transfer system 110 interconnected with the communication network 108 as shown in FIGS. 1-2. FIG. 2 illustrates a block diagram of the call transfer system 110. The call transfer system 110 comprises a processor 110A and a corresponding memory 10B. The processor 110A can include a conventional computer-readable storage medium such as a server, a computer, or other computing means. The memory 10B can comprise conventional means such as a hard disk, flash memory, Random Access Memory (RAM), and/or combinations of like storage media for storing information in a desirable format such as, for example, a database.

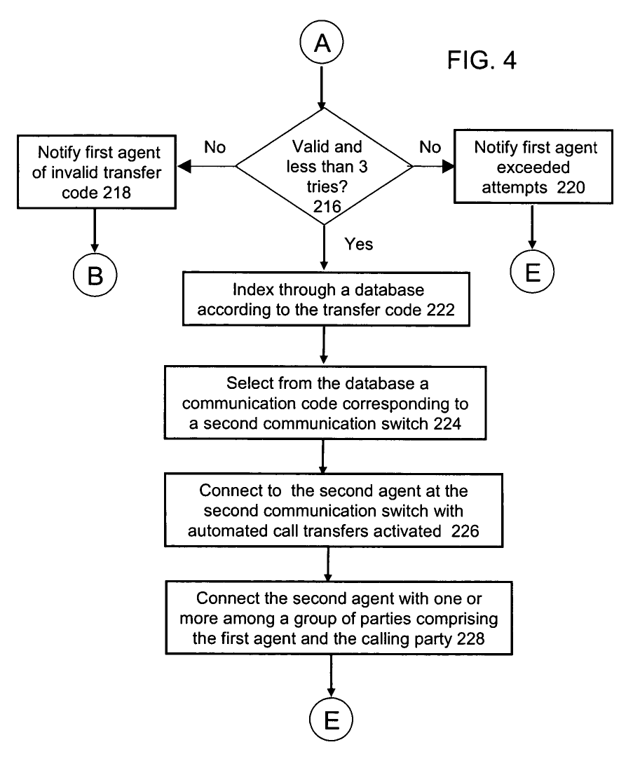

FIGS. 3-4 show flow charts depicting a method 200 in accordance with an embodiment of the present invention. Method 200 begins with step 202 where the first agent 106A receives a call from a calling party 102A. The first agent 106A determines in step 204 that the calling party 102A needs to be transferred to a second agent 106B. This determination could happen for any number of reasons. For instance, the calling party 102A may have accidentally dialed the wrong service center. In step 206 the first agent determines that the first communication switch operating in service center 104A does not support an automated call transfer to the second agent 106B. As noted earlier, this can occur in a service provider's network where there may be a lack of interoperability in the call transfer feature between a number of service centers 104.

Accordingly, when such an issue is detected, the first agent 106A places the calling party 102A in step 208 on hold utilizing conventional means such as depressing a Flash button on a conventional phone (or entering a code), which signals the first communication switch of service center 104A to invoke the hold feature. The first agent 106A in step 210 opens another conventional phone line and calls the call transfer system 110 from a known number or speed dial code.

In step 212, the processor 10A of the call transfer system 110 is programmed to receive a request from the first agent 106A to interconnect to the second agent 106B at the second communication switch of service center 104B. In a supplemental embodiment, the foregoing step can take place in the processor 110A by way of voice and/or manual interactions with the first agent 110 similar to what is provided in a conventional IVR (Interactive Voice Response) system. That is, the processor 110A can be programmed to present a voice menu system (herein referred to as in the IVR function) to guide the first agent 106A in the process of transferring the calling party 102A to the second agent 106B. The IVR function can be as sophisticated as needed. For instance the IVR function can request by way of a pre-recorded (or synthesized) voice message a transfer code from the first agent 106A. If the first agent 106A does not have a transfer code, it could request the IVR function to dictate a selectable list of agents in the database of memory 110B according to, for example, a skill set (billing, technical support, and so on) and/or region (Northeaster US, Southern Illinois, etc.) of the second agent 106B.

The response from the first agent 106A can be provided as one or more DTMF (Dual Tone Multi-Frequency) signals and/or one or more voice messages identifying the transfer code singly or in combination. Similar to the prior art description, the transfer code can be printed or on the computer screen of the first agent 106A. More importantly, the database utilizes the same transfer codes, as the first agent 106A would have used if automated call transfers had been active in the communication switch of its service center 104A. Accordingly, the agents 106 of the service provider do not have to learn a new set of codes under the present invention.

Referring to FIG. 4, the processor 110A is further programmed to validate the transfer code in step 216. If the transfer code is invalid (i.e., it does not identify an agent in the selectable list of agents stored in the memory 110B), the processor 110A is programmed to notify the first agent 106A in step 218 of the invalid transfer code and thereafter proceeds back to step 212 of FIG. 3 to prompt further responses from the first agent 106A. If the first agent 106A enters an invalid transfer code more than a predetermined number of times (illustrated as a threshold of three tries in FIG. 4), the processor 110A then proceeds to step 220 where it notifies the first agent 106A that s/he has exceeded the number of attempts allowed, and thereby terminates connection with the first agent 106A. The notification steps 218 and 220 can be carried out by way of a pre-recorded (or synthesized) voice message, and/or an audible alert indicating a problem entry.

If, on the other hand, the transfer code is determined to be valid in step 216, then the processor 110A proceeds to step 222 where it indexes through the database according to the transfer code provided by the first agent 106A to find the second agent 106B. The transfer code can comprise a portion of one or more among a group of identifiers including an identification of the second agent 106B, an identification of an IVR of the second agent, a skill set of the second agent, a region of the second agent, a numeric code, an alphabetic code, an alpha-numeric code, and a portion of a corresponding number of the calling party. The identification of the second agent 106B can be the agents name, a code corresponding to the agent or any form of identifier that can be used to identify the second 106B. An identifier for the IVR of the second agent 106B can be the name of the service center 104B, a code for identifying said service center, or other like identification classification. Similarly, any numeric, alphabetic or a combination of alphabetic and numeric sequence(s) can be used to identify the second agent 106B.

Once the second agent 106B has been located in step 222, the processor 110A proceeds to step 224 where it selects from the database a communication code corresponding to the second communication switch of service center 104B associated with the second agent 106B. The communication code can be a phone number of the second agent 106B at service center 104B. Alternatively, the communication code can be any identifier or sequence of identifiers that the processor 110B can utilize to link the first agent 106A to the second agent 106B at the second communication switch of service center 104B.

Once the communication code has been identified, the processor 110B proceeds to step 226 where it instructs the communication network 108 to connect the first agent at the first communication switch to the second agent 106B at the second communication switch of service center 106B. Additionally, the processor 110A informs the second communication switch to activate automatic call transfers so that the second agent 106B can readily transfer the calling party 102A in the event further transfers are deemed necessary. In step 228, the processor 110A connects the second agent 106B to the first agent 106A and/or the calling party 102A as the circumstances may dictate.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents.

As already noted, the present invention can be realized in hardware, software, or a combination of hardware and software. The present invention also can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can also be embodied in other forms without departing from the spirit or essential attributes thereof. For instance, method 200 can be simplified so that the call transfer system 110 processes transfers according to steps 212, 222, 224, 226 and 228 without the use of a sophisticated database or validation steps 216-220. Accordingly, reference should be made to the following claims, rather than to the foregoing specification, as indicating the scope of the invention.

What is claimed is:

1. In a call transfer system a computer-readable storage medium for transferring a calling party communicating with a first agent at a first communication switch when said first communication switch does not support automated call transfers, the storage medium of the call transfer system comprising computer instructions for:
receiving a call from the first agent;
selecting a second agent at a second communication switch according to a request received from the first agent;
connecting the second agent at the second communication switch with one or more of a group of parties comprising the calling party and the first agent; and
activating automated call transfers at the second communication switch.

2. The computer-readable storage medium of claim 1, wherein the request comprises a transfer code for identifying the second agent.

3. The computer-readable storage medium of claim 2, wherein a portion of the transfer code is represented by one or more DTMF (Dual Tone Multi-Frequency) signals supplied by the first agent.

4. The computer-readable storage medium of claim 2, wherein a portion of the transfer code is represented by one or more voice messages supplied by the first agent.

5. The computer-readable storage medium of claim 2, wherein said transfer code comprises a portion of one or more among a group of identifiers comprising an identification of the second agent, an identification of an IVR of the second agent, a skill set of the second agent, a region of the second agent, a numeric code, an alphabetic code, an alpha-numeric code, and a portion of a corresponding number of the calling party.

6. The computer-readable storage medium of claim 5, wherein the storage medium further comprises computer instructions finding the second agent according to the transfer code.

7. The computer-readable storage medium of claim 6, wherein a communication code is associated with each agent of the selectable list of agents, and wherein a communication code corresponding to the second agent is used by the connecting step to connect to the second communication switch.

8. The computer-readable storage medium of claim 2, further comprises computer instructions for:
rejecting the request when the transfer code submitted by the first agent is invalid; and
terminating the connection between the call transfer system and the first agent after a predetermined number of rejections have been detected.

9. The computer-readable storage medium of claim 1, wherein the call transfer system comprises an IVR (Interactive Voice Responder) having a database for storing the selectable list of agents, and wherein the selecting step further comprises computer instructions for interacting with the first agent to select the second agent from the database.

10. The computer-readable storage medium of claim 9, wherein the request comprises a transfer code for identifying the second agent, wherein said transfer code comprises a portion of one or more among a group of identifiers comprising an identification of the second agent, an identification of an IVR of the second agent, a skill set of the second agent, a region of the second agent, a numeric code, an alphabetic code, an alpha-numeric code, and a portion of a corresponding number of the calling party, and wherein the storage medium further comprises computer instructions further indexing through the database according to the transfer code to find the second agent.

11. The computer-readable storage medium of claim 10, wherein the database further comprises a communication code associated with each agent of the selectable list of agents, and wherein a communication code corresponding to the second agent is used in the connecting step to connect to the second communication switch.

12. The computer-readable storage medium of claim 10, wherein the selecting step further comprises computer instructions for:
validating the transfer code provided by the first agent;
when said transfer code is invalid, informing the first agent the transfer code is invalid by way of the IVR of the call transfer system; and
terminating the connection between the call transfer system and the first agent after a predetermined number of rejections have been communicated.

13. A call transfer system coupled to a communication network for transferring a calling party communicating with a first agent at a first communication switch when said first communication switch does not support automated call transfers, comprising:
a memory; and
a processor coupled to the memory, wherein the processor is programmed to:
receive a call from the first agent;
select from the memory a second agent at a second communication switch according to a request received from the first agent;
connect the second agent at the second communication switch with one or more of a group of parties comprising the calling party and the first agent; and
activate automated call transfers at the second communication switch.

14. The call transfer system of claim 13, wherein said memory comprises a database for storing the selectable list of agents, and wherein at the select step the processor is further programmed to interact with the first agent to select the second agent from the database

15. The call transfer system of claim 14, wherein the request comprises a transfer code for identifying the second agent, wherein said transfer code comprises a portion of one or more among a group of identifiers comprising an identification of the second agent, an identification of an IVR of the second agent, a skill set of the second agent, a region of the second agent, a numeric code, an alphabetic code, an alpha-numeric code, and a portion of a corresponding number of the calling party, and wherein the storage medium further comprises computer instructions further indexing through the database according to the transfer code to find the second agent.

16. The call transfer system of claim 15, wherein said transfer code is represented by one or more of a group of responses supplied by the first agent comprising one or more DTMF (Dual Tone Multi-Frequency) signals and one or more voice messages.

17. The call transfer system of claim 14, wherein the database further comprises a communication code associated with each agent of the selectable list of agents, and wherein a communication code corresponding to the second agent is used by the connect step to connect to the second communication switch.

18. The call transfer system of claim 15, wherein at the select step the processor is further programmed to:
validate the transfer code provided by the first agent;
when said transfer code is invalid, inform the first agent the transfer code is invalid; and
terminate the connection between the call transfer system and the first agent after a predetermined number of rejections have been communicated.

19. The call transfer system of claim 14, wherein the interact step comprises voice messages supplied to the first agent by the call transfer system, and one or more among a group of responses supplied by the first agent comprising one or more DTMF signals and one or more voice messages.

20. In a service center, a method comprising the steps of:
a first agent,
receiving a call from a calling party at a first communication switch;
determining that the calling party needs to be transferred to a second agent;
determining that the first communication switch does not support an automated call transfer to the second agent;
placing the calling party on hold;
calling a call transfer system;
supplying to the call transfer system a transfer code corresponding to the second agent;
the call transfer system,
receiving a call from the first agent;
selecting the second agent at a second communication switch according to the transfer code received from the first agent;
connecting the second agent at the second communication switch with one or more of a group of parties comprising the calling party and the first agent; and
activating automated call transfers at the second communication switch.
